(19) United States
(12) Patent Application Publication
(10) Pub. No.: US 2018/0276313 A1
(43) Pub. Date: Sep. 27, 2018

(54) SYSTEM AND METHOD FOR PART IDENTIFICATION

(71) Applicant: RB Distribution, Inc., Colmar, PA (US)

(72) Inventors: Chris Comenzo, Philadelphia, PA (US); Wade Hilburn, Frisco, TX (US); William Cline, Saint Louis, MO (US); Nick Matejcic, Fenton, MO (US)

(73) Assignee: RB Distribution, Inc., Colmar, PA (US)

(21) Appl. No.: 15/933,994

(22) Filed: Mar. 23, 2018

Related U.S. Application Data
(60) Provisional application No. 62/475,773, filed on Mar. 23, 2017.

(51) Int. Cl. G06F 17/30; G06Q 30/06; G06Q 30/02; G07C 5/00; G06F 3/0481

(52) U.S. Cl. CPC G06F 17/30994; G06Q 30/06; G06F 3/0481; G07C 5/008; G06Q 30/02

(57) ABSTRACT

A system and method for identifying parts on a vehicle and maintaining the parts within a system is disclosed. The system and method include submitting a vehicle identification number (VIN) to determine demand for parts associated with the vehicle identified by the VIN, generating a product delivery record (PDR) for at least one of the parts, entering the PDR of the at least one of the parts into a tracking system, determining the ultimate destination for the vehicle identified by the VIN, on a condition that the vehicle is destined to be dismantled, creating at least one dismantle report associated with either the vehicle or the parts, printing tags associated with the parts being dismantled from the vehicle, the tags providing at least one of routing or destination information for the part, and locating the parts based on the tag based on the routing or destination information.

### CROSS-REFERENCED TO RELATED APPLICATION

This application claims priority to U.S. Provisional Application No. 62/475,773, filed Mar. 23, 2017, which is incorporated by reference as if fully set forth.

### FIELD OF INVENTION

The present invention is directed to the identification of parts in the automotive industry, and more particularly, to a system and method for part identification.

### BACKGROUND

Salvage part supply companies routinely use software that utilizes year, make and model of vehicle in conjunction with Hollander numbers to identify parts. Hollander numbers describe a system used by the Hollander Interchange Manual that links vehicle part numbers with vehicle parts that are interchangeable. The Hollander numbers can be used to look up a part number and car to find parts that will perform the same function when replaced or modified. The numbers lead to a variety of parts options and also are used to sell parts online and for inventory at auto salvage yards. While these identification criteria have proven useful in establishing an effective part numbering system, there are occasions when the system fails to supply enough descriptive granularities to properly identify a part.

For example, there are instances where existing identification methods can identify general attributes of a part such as the part type, including bumper, door panel, or the like, for example, and the year make and model of vehicle it fits. However, existing systems may not be able to identify more detailed attributes of the part, such as trim level or type, including premium leather package, or leather color, for example. Therefore, a need exists to provide a system and method for identification of parts that provides additional descriptive granularity to more accurately identify a part.

### SUMMARY OF THE INVENTION

A system and method for identifying parts on a vehicle and maintaining the parts within the system is described. The system and method includes submitting a vehicle identification number (VIN) to determine demand for one or a series of parts associated with the vehicle identified by the VIN, generating a product delivery record (PDR) for at least one of the one or series of parts associated with the vehicle identified by the VIN, entering the PDR of the at least one of the one or series of parts associated with the vehicle identified by the VIN into a tracking system, determining the ultimate destination for the vehicle identified by the VIN, on a condition that the vehicle is destined to be dismantled, creating at least one dismantle report associated with either the vehicle identified by the VIN or the at least one the one or series of parts associated with the vehicle identified by the VIN, printing tags associated with the parts being dismantled from the vehicle, the tags providing at least one of routing or destination information for a part identified using the VIN of the vehicle, and locating the parts based on the tag based on the routing or destination information.

### BRIEF DESCRIPTION OF THE DRAWINGS

A more detailed understanding may be had from the following description, given by way of example in conjunction with the accompanying drawings wherein:

FIG. 1 illustrates a system for providing the part identification for a vehicle associated with the present invention;

FIG. 2A illustrates an entry screen where the VIN may be input;

FIG. 2B illustrates a input in which any damage to the vehicle may be entered into the system of FIG. 1;

FIG. 3 illustrates a method for providing the part identification of the present invention;

FIG. 4 illustrates the association of the part identification with the reseller price and the reseller's part description;

FIG. 5 illustrates the designated plan for the identified vehicle;

FIG. 6 illustrates a screen depiction of the type of information contained within the system of FIG. 1 after the PDR is created and the PDR parts are entered into the system of FIG. 1;

FIG. 7 illustrates the screen depiction of FIG. 6 providing detail on parts that are in demand and match a line item;

FIG. 8 illustrates a presentation of information regarding the handling of recovered parts entered in the system of FIG. 1;

FIG. 9 illustrates a dismantling report of the system of FIG. 1;

FIG. 10 illustrates a screen illustrating parts within the system of FIG. 1 that may be used for printing tags associated with parts;

FIG. 11 illustrates the print screens for printing tags within the present invention; and

FIG. 12 illustrates the depiction of location information for parts within the present system.

### DETAILED DESCRIPTION

The present invention includes a part identification method that uses a vehicle's seventeen character Vehicle Identification Number (VIN) to identify a part to provide additional information that is not conveyed using the Hollander numbers and year, make and model of the vehicle. Utilizing simplified databases that maintain detailed information on parts ordered by VIN, the VIN is capable of providing part details that cannot be accessed by the Hollander/year, make, and model combination. Once a part has been identified by VIN, its corresponding Hollander number can be readily obtained, as well, thereby enabling backward compatibility with legacy systems. However, having access to the additional attributes provided by the VIN based identification system, such as trim level, color, and the like, greatly increases the probability of obtaining the exact part required and minimizes the instances of “similar” parts being provided instead of the correct part being provided.

A system and method for identifying parts on a vehicle and maintaining the parts within the system is disclosed. The system and method include submitting a vehicle identification number (VIN) to determine demand for one or a series of parts associated with the vehicle identified by the VIN, generating a product delivery record (PDR) for at least one of the one or series of parts associated with the vehicle identified by the VIN, entering the PDR of the at least one of the one or series of parts associated with the vehicle identified by the VIN into a tracking system, determining the ultimate destination for the vehicle identified by the VIN, on a condition that the vehicle is destined to be dismantled, creating at least one dismantle report associated with either the vehicle identified by the VIN or the at least one the one or series of parts associated with the vehicle identified by the VIN, printing tags associated with the parts being dismantled from the vehicle, the tags providing at least one of routing or destination information for a part identified using the VIN of the vehicle, and locating the parts based on the tag based on the routing or destination information.

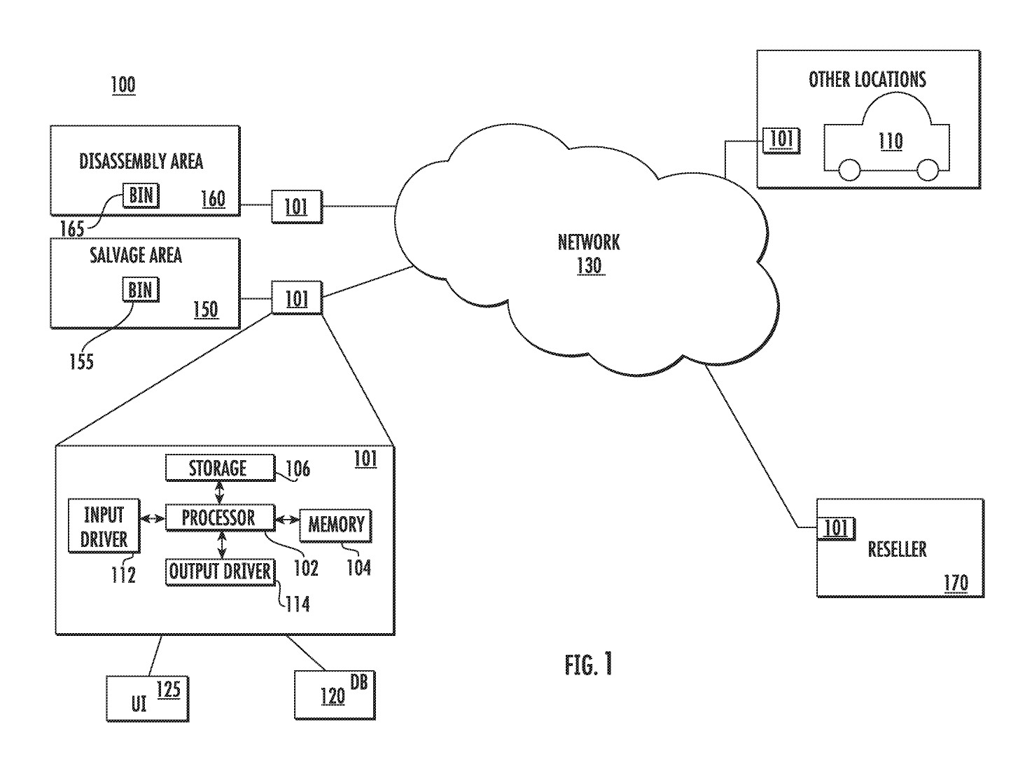

FIG. 1 illustrates a system 100 for providing the part identification of the present invention. In addition to providing the part identification of a vehicle 110 using the VIN of the vehicle, system 100 calculates or determines the value of the vehicle 110 based on the sum of the values of the parts identified as being within the vehicle. The value of the vehicle 110 may be used in bidding on salvaged or totaled vehicles at auction, or otherwise may be used to determine whether to purchase a vehicle.

A VIN, also referred to as a chassis number, is a unique code, including a serial number, used by the automotive industry to identify individual motor vehicles, towed vehicles, motorcycles, scooters and mopeds, as defined in ISO 3833. VINs are based on two related standards, originally issued by the International Organization for Standardization (ISO)—ISO 3779 and ISO 3780, respectively. Compatible but different implementations of these ISO standards have been adopted by the European Union and the United States, respectively. Although the implementations generally provide the same information.

Generally, the VIN is 17 digits and includes a world manufacturer identifier, an indication of “the general characteristics of the vehicle,” and an indication that provides “clear identification of a particular vehicle.”

More specifically, the first three characters of the seventeen-character VIN uniquely identify the manufacturer of the vehicle using the world manufacturer identifier or WMI code. The first character of the WMI is the region in which the manufacturer is located.

The fourth to eighth positions in the VIN are the vehicle descriptor section (VDS). The VDS is used to identify the vehicle type, and may include information on the automobile platform used, the model, and the body style. Each manufacturer has a unique system for using this field. Specifically, the eighth digit may be used to identify the engine type whenever there is more than one engine choice for the vehicle. For example, for the 2007 Chevrolet Corvette, U is for a 6.0 L V8 engine, and E is for a 7.0 L V8.

The ninth position in the VIN may be used as a check digit.

The tenth to seventeenth positions are used as the vehicle identifier section (VIS). These positions may be used to identify the individual vehicle in question and may include information on options installed or engine and transmission choices.

System 100 includes an example device 101 in which one or more features of the disclosure can be implemented. The device 101 can include, for example, a computer, a gaming device, a handheld device, a set-top box, a television, a mobile phone, or a tablet computer. The device 101 includes a processor 102, a memory 104, a storage 106, one or more input devices, and one or more output devices. The device 101 can also optionally include an input driver 112 and an output driver 114. It is understood that the device 101 can include additional components not shown in FIG. 1.

In various alternatives, the processor 102 includes a central processing unit (CPU), a graphics processing unit (GPU), a CPU and GPU located on the same die, or one or more processor cores, wherein each processor core can be a CPU or a GPU. In various alternatives, the memory 104 is be located on the same die as the processor 102, or is located separately from the processor 102. The memory 104 includes a volatile or non-volatile memory, for example, random access memory (RAM), dynamic RAM, or a cache.

The storage 106 includes a fixed or removable storage, for example, a hard disk drive, a solid state drive, an optical disk, or a flash drive. The input devices include, without limitation, a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). The output devices include, without limitation, a display, a speaker, a printer, a haptic feedback device, one or more lights, an antenna, or a network connection (e.g., a wireless local area network card for transmission and/or reception of wireless IEEE 802 signals).

The input driver 112 communicates with the processor 102 and any input devices, and permits the processor 102 to receive input from the input devices. The output driver 114 communicates with the processor 102 and any output devices, and permits the processor 102 to send output to the output devices. It is noted that the input driver 112 and the output driver 114 are optional components, and that the device 101 will operate in the same manner if the input driver 112 and the output driver 114 are not present.

The device 101 may include, or be linked to, a database 120, which may include information that is indexed according to the VIN of the vehicles, as well as, a mapped part list for each of the respective vehicles. The database 120 may provide the ability to transition between the VIN of a vehicle and the Hollander numbers of the parts, as necessary.

Interconnected with the device 101 may be a user interface 125. This user interface 125 may be located proximate to the computing system device 101, or if the device 101 is located remotely, the user interface 125 may be provided at a salvage yard, for example. User interfaces 125 attached to other devices 101 may also connect with the computing system via the network 130 or other accessing mechanism in order to provide information, such as VIN numbers, and determine the value of the vehicle 110 identified by such a VIN. By way of example, such a user interface 125 interconnected with a device 101 may be an individual computing device, such as a laptop, iPhone, or iPad that may be on-site with a user where an available vehicle is located or going to be located. Another user interface 125 interconnected with a device 101 may be located proximate to the salvage area 150 or disassembly area 160. This user interface 125 interconnected with device 101 may enable interaction with the system 100 to identifying parts entering, or going to enter, the salvage area 150 or disassembly area 160.

The parts may enter via the entering of a vehicle 110 identified by the VIN, and may be disassembled at a disassembly area 160 the salvage area 150, or may be previously disassembled before entering the yard. Once disassembled, the system 100 may provide a destination for the parts, or groups of parts, from the vehicle associated with the VIN. This may include parts destined to go to a selected reseller 170, parts destined for a reseller who has placed a requisition for the parts, where the requisition is met by the parts of the vehicle identified by the VIN. This location may range from a pile to a bin 155, as appropriate. A bin 165 within disassembly area 160 may be used to stage parts as they are disassembled from the vehicle 110.

Operationally, a VIN for a vehicle 110 may be input into a user interface 125 of a device 101 within system 100. System 100 may utilize processor 102 via output driver 114 to access a database 120. In accessing the database 120, the demand for the parts of the vehicle 110 may be determined. The VIN number may be used to determine the value of each of the respective parts on the vehicle 110. As would be understood by those possessing an ordinary skill in the art, demand plays a factor in the value of a given part or set of parts. For example, the demand associated with a gear box affects the price and therefore the value of the gear box. From the demand for each part of vehicle 110, a value of the vehicle 110 may be determined. A PDR may be created within device 101 for the vehicle 110. The PR may include determining the destination of vehicle 110 and/or parts of the vehicle 110 and designating the vehicle 110 as a dismantle.

System 100 includes a series of printing devices capable of printing tags for marking parts of vehicle 110 to aid in locating and tracking the parts. That is, the system 100 may provide a printer or series of printers, or other marking means, to allow for the marking and designating of parts, as the parts enter the salvage area 150 or are disassembled or dismantled in the disassembly area 160 from the vehicle.

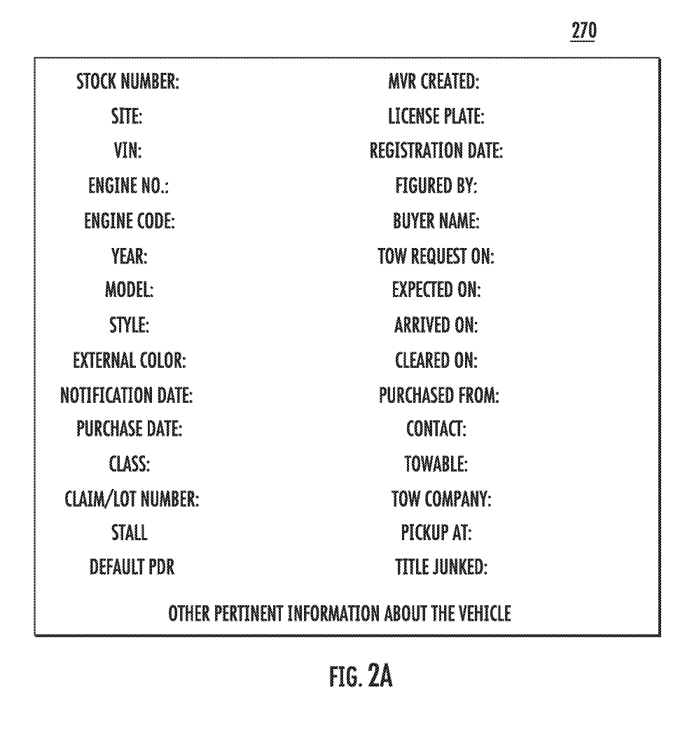

FIG. 2A illustrates a user input screen 270 for entering information regarding a vehicle of interest. Input screen 270 may allow a user to enter the VIN of a vehicle. The input screen 270 may include other information and other formatting as would be understood by those possessing an ordinary skill in the art. Additionally, inputs may include scanners to scan the VIN or other parts, cameras to image a vehicle or specific parts and use an automated process of recognition of the vehicle of the part, for example, and other techniques for identifying vehicles.

Input screen 270 may include inputs for stock number, site, VIN, engine no., engine code, year, model, style, external color, notification date, purchase date, class, claim/lot number, stall, default PDR, MVR created, license plate, registration date, figured by, buyer name, tow request, expected delivery, arrival, clearance, entity purchased from, contact, information on towability, pickup location, and whether the title is junked. Input screen 270 may include other pertinent information about the vehicle as well. This information may be entered using a freeform user entry block or may have designated information blocks that may be added or included. Each entry or piece of information may be entered manually, or may be developed or determined from the VIN, as described herein.

FIG. 2B illustrates an input 200 through which damage to the vehicle may be entered into the system 100. In determining the value or parts available based on the VIN of the vehicle an accounting need be made for any damage on the vehicle. Using input 200 the damage to a prospective or accepted vehicle may be entered. While input 200 is illustrative only, and other inputs may be used to convey damage or other information into system 100, input 200 enables a description of inputting damage to the vehicle. As would be understood by those possessing an ordinary skill in the pertinent art, depictions of the inside of the vehicle, the engine compartment, and other elements of the vehicle may be depicted in order for system 100 to be provided information to assess the value of the vehicle.

As depicted, input 200 includes a vehicle 210 including a front bumper 215 and a rear bumper 205. Wheels 220 may be included within input 200, including left rear wheel 220a, left front wheel 220b, right rear wheel 220c, and right front wheel 220d, collectively referred to as wheels 220. Further, input 200 may include door collectively referred to as doors 225, including back left door 2250a, front left door 225b, back right door 225c, and front right door 225d. As would be understood to those with skill in the art, other vehicles may include more or less doors, such as two-door vehicles, three-door hatchback and the like. Based on an entered VIN number input 200 may account for such variations in vehicles, or alternatively, a user may account for such variations in selecting aspects of input 200.

Input 200 may include roof 230, rear window 235, front window 240, door or side windows 245, including back left door window 245a, front left door window 245b, back right door window 245c, and front right door window 245d. Input 200 may include the hood 250 and trunk 255, grill 260 and rear grill 265, by way of examples only.

Input 200 may be utilized to provide information into system 100, for example, in the event that the front bumper 215 is destroyed in an accident, it may be problematic to account for the value of front bumper 215 in assessing vehicle 210. Further, additional damage may be found on the parts of vehicle 210 from the front impact, such as grill 260. Such damage may or may not be seen in the initial inspection and, as such, vehicle 210 may be designated for further examination of grill 260, for example. By inputting areas of the vehicle that are damaged through input 200, system 100 may determine areas of input and identify parts that may be impacted by such damage. This may benefit by enabling system 100 to discount the value of a salvaged vehicle by the reduced amount and account for the value of such parts, or by providing a notation that additional inspection is required to determine if the impacted parts can be recovered. As illustrated in FIG. 2, a two-dimensional view of vehicle 210 is depicted for allowing the input of damage to the vehicle in question.

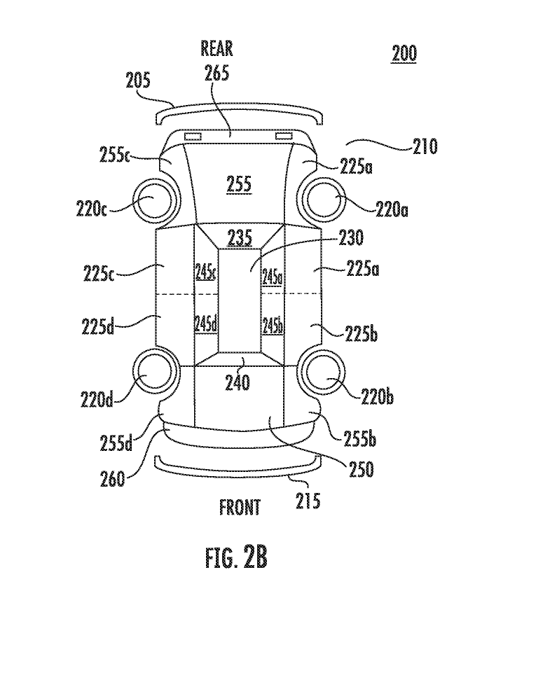

FIG. 3 illustrates a method 300 for providing the part identification of the present invention that may be performed in the system of FIG. 1. Method 300 includes the steps of submitting the VIN to determine demand at step 310. As part of identifying the parts, the VIN number may be used to determine the value of each of the respective parts on a vehicle. As would be understood by those possessing an ordinary skill in the art, demand plays a factor in the value of a given part or set of parts. For example, the demand associated with a gear box affects the price and therefore the value of the gear box. The method initiates by inputting or submitting a VIN to determine the demand for the parts associated with the vehicle with that VIN. Once the VIN is submitted, the system queries the database and determines the demand associated with the respective parts from the vehicle identified by the VIN. This includes vehicle parts associated with particular resellers.

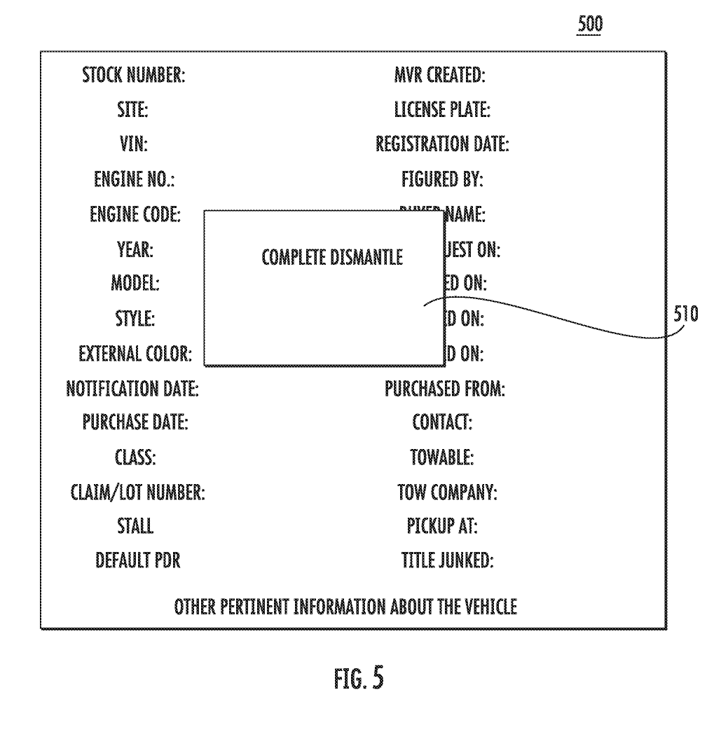

Method 300 includes generating a PDR at step 320 and entering PDR parts at step 330. The information included in a PDR is described here with respect to FIG. 6.

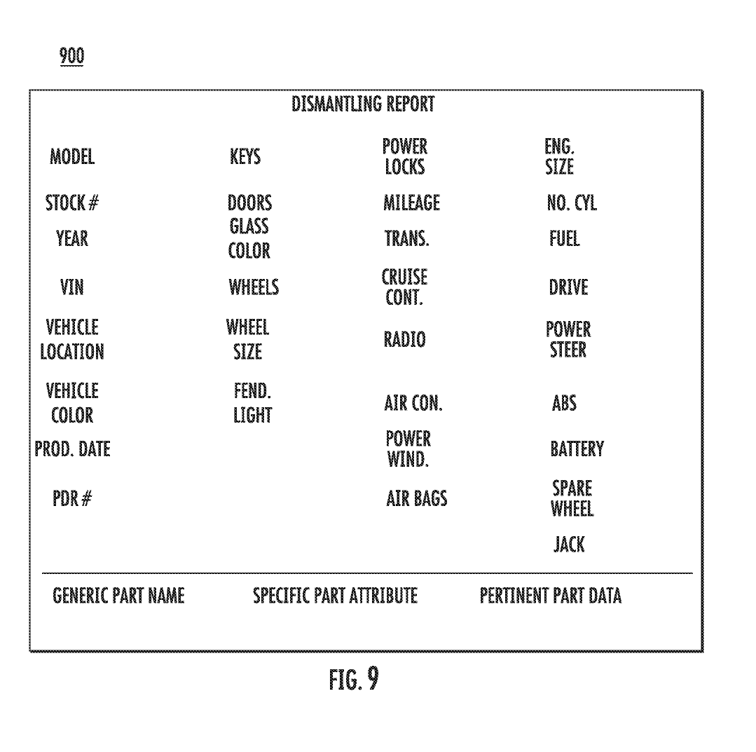

Method 300 includes determining the destination of vehicle and/or parts of the vehicle at step 340 and creating a dismantle report and changing the status of the vehicle identified by the VIN at step 350. The dismantle report is described in greater detail with respect to FIG. 9.

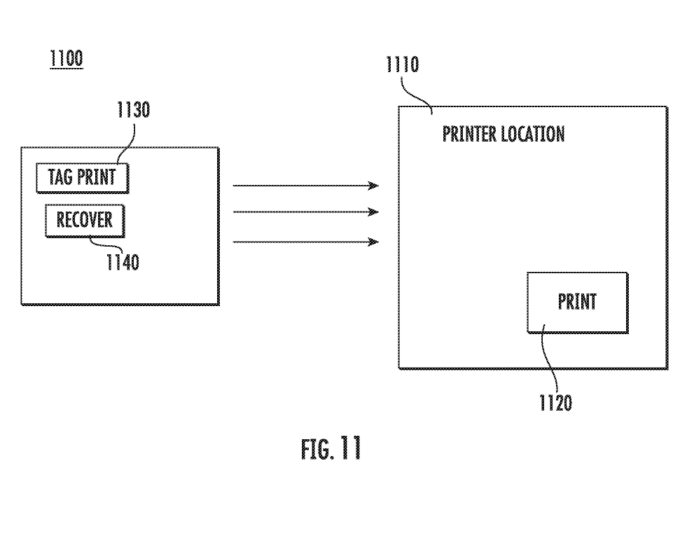

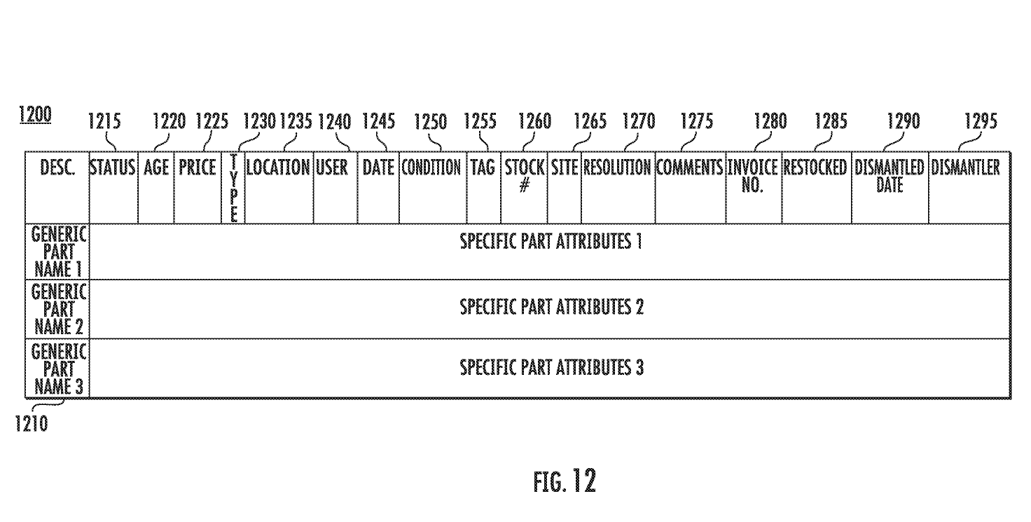

Method 300 includes printing tags at step 360 as is described in greater detail with respect to FIG. 11. System 100 and method 300 include locating and tracking the parts at step 370 and described in greater detail in FIG. 12.

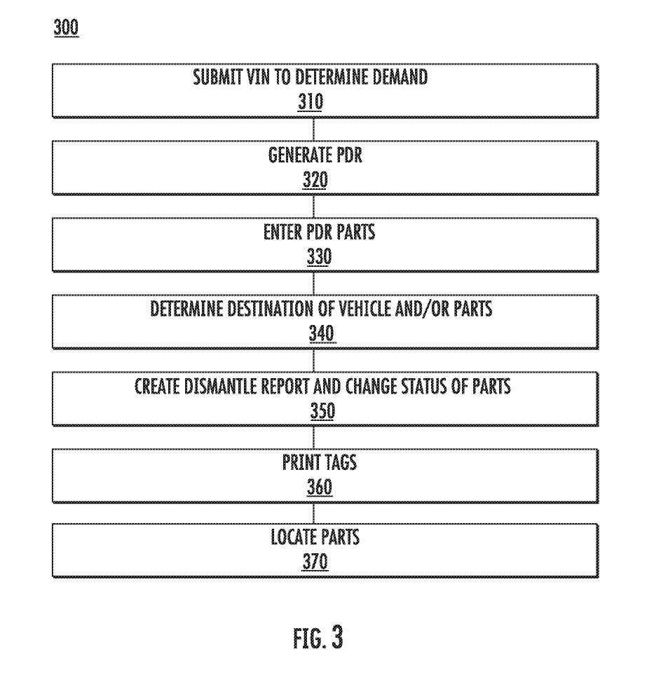

Once the VIN is submitted and the parts identified and valued, such as through inputs 200 and 270, for example, a product delivery record (PDR) may be created. This product delivery record may indicate that parts identified on the vehicle based on the submitted VIN are for delivery to a particular reseller. At this point, the part identification may be associated with the reseller price and the reseller's part description. This allows a reviewer to accurately identify the requested part on the vehicle. This association is depicted in FIG. 4. As illustrated in FIG. 4, a screen 400 may depict a generic part name and specific part attributes 410 along with the associated price 420 and pertinent part data including value 430. A generic part name may be, for example, headlight and specific part attributes may include xenon as the type of headlight. The price of this part may be $15.

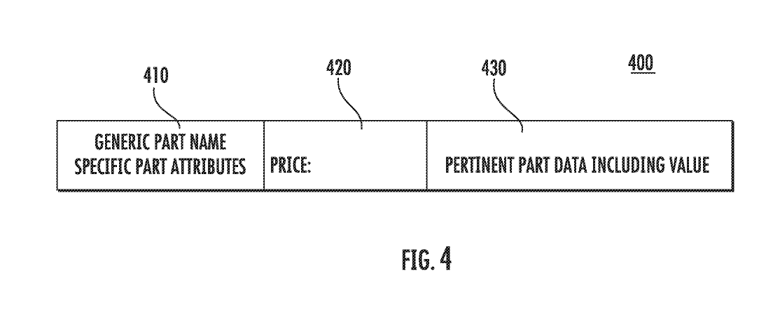

Additionally, system 100 may determine the best method of realizing the value in the vehicle identified by the submitted VIN. As illustrated in FIG. 5, the user input screen 270 of FIG. 2A may be overlayed with a pop-up window 510 providing recommendation for the best course of realizing value from the entered vehicle. As illustrated in FIG. 5, the identified vehicle may be destined for a complete dismantle. Other alternatives to dismantling the vehicle include removal of selected and designated parts, for example.

FIG. 6 illustrates a screen depiction 600 of the type of information contained within system 100 after the PDR is created and the PDR parts may be entered into the system. This may include all parts on the vehicle identified by the VIN, or just parts having a true recovery opportunity, i.e., those parts that have been identified as needed by a reseller. The PDR parts may be entered in a drop down menu, for example. As illustrated in FIG. 6, a drop down menu may identify the returned price, reseller or redistributor and a part description for any given one of the PDR parts. Once a given part is selected in the drop down menu, the price may dramatically change to the value the reseller or redistributor has offered. This value change is reflected in FIG. 6. In the screen depiction 600, there is shown a generic part name column 610 that provides a generic name of the part or parts that may extend beyond specifics about the part itself. A column 620 may include the specific part name of the part or parts that may provide additional detail in the name of the part including, but not limited to, color or style information. Pertinent part information may be included in a column 630 for any part or parts that include additional data regarding a specific part. A price column 640 and details column 650 may also be included. These columns may include the price and any other details associated with the part or parts identified.

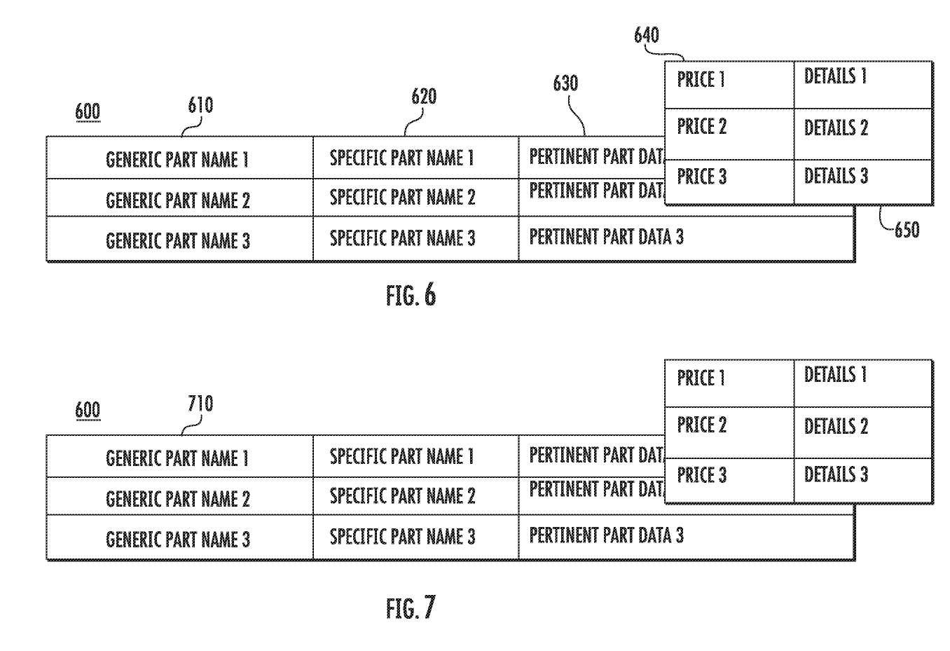

FIG. 7 illustrates the screen depiction 600 of FIG. 6 providing detail on parts that are in demand and match a line item. If multiple parts were in demand that matched a line item, the selected parts may be identified or highlighted 710, such as by using color or bold, for example. In this illustration, a user of system 100 may select any of a number of categories of parts for viewing including only those parts that have recovery opportunities. System 100 may enter the parts that have such opportunities without adding the parts into the local inventory, as the local reseller may only pass the parts through to the destined reseller. Alternatively, the status of such parts may be identified in other ways as would be understood by those possessing an ordinary skill in the pertinent arts.

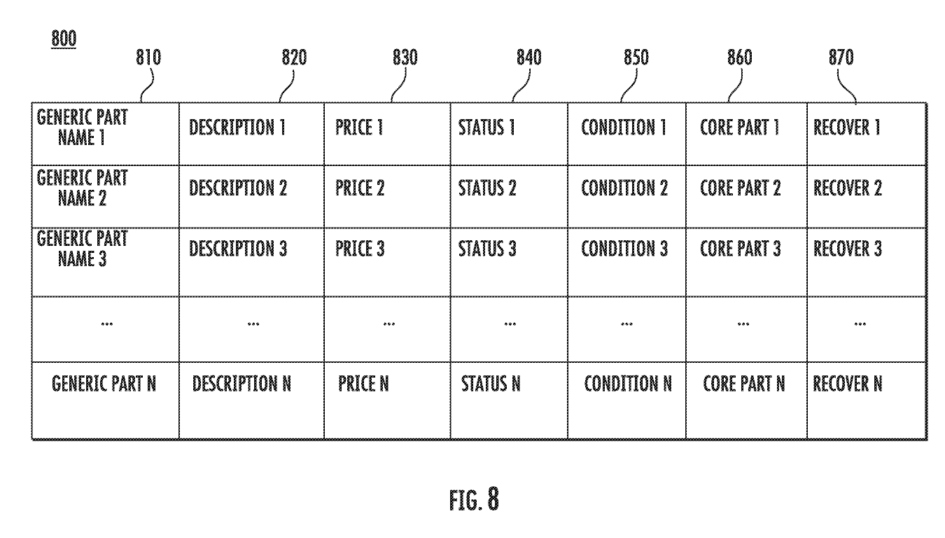

FIG. 8 illustrates a presentation 800 of information regarding the handling of recovered parts entered in system 100. In the presentation 800, there is shown a generic part name column 810 that provides a generic name of the part or parts that may extend beyond specifics about the part itself. A column 820 may provide a description of the part and may include additional details of the part. A price column 830 and status column 840 may also be included. These columns may include the price and the current status of the part, such as if the part is going to be dissembled or if the part is already ready for sale. A condition column 850 may also be provided to provide details on the condition of the product. For example, if the product is an engine, the condition column may provide detail on the number of miles on the engine. Core part information 860 and recover information 870 may also be included.

FIG. 9 illustrates a dismantling report 900 of system 100. The information within the dismantling report may be included one the vehicle is identified for dismantling, once it is dismantled. Once the information is within system 100, the information may remain in the system 100 until the part no longer is tracked within system 100.

Once the vehicle identified by the VIN is designated as being dismantled, based on the destination for the vehicle discussed in FIG. 5, a dismantling report may be created and the vehicle identified as dismantled. Once dismantled the vehicle may no longer be tracked by VIN number, since the vehicle does not exist, and each of the parts within the dismantling report 900 may be tracked individually. A link that the arts came from a vehicle with an identified and specified VIN may exist. The dismantling report 900 identifies the real recovery opportunities that exist for the parts and has those parts designated as real recovery earmarked for delivery to the appropriate reseller.

Dismantling report 900 may be used for each part removed from the vehicle. For example, if a driver door is removed, the dismantling report 900 may be filled out for that part. Alternatively, the dismantling report 900 may be filled for each vehicle dismantled to capture the parts from a specific vehicle for example. In either situation, each part is captured and identified.

Dismantling report 900 may include areas to record and enter information, for the dismantle or along with, such as concurrently, with the dismantle. As illustrated in FIG. 9, information may include model, stock #, year, VIN, vehicle location, vehicle color, production date, PDR#, keys, doors, glass color, wheels, wheel size, fender light, power locks, mileage, transmission, cruise control, radio, air conditioner, power windows, air bags, engine size including number of cylinders, fuel type, drive type, power steering, ABS system, battery, spare wheel, and jack, by way of non-limiting example only. This dismantle report may be filled as the dismantle proceeds. Alternatively, this report may be prefilled based on the VIN of the vehicle.

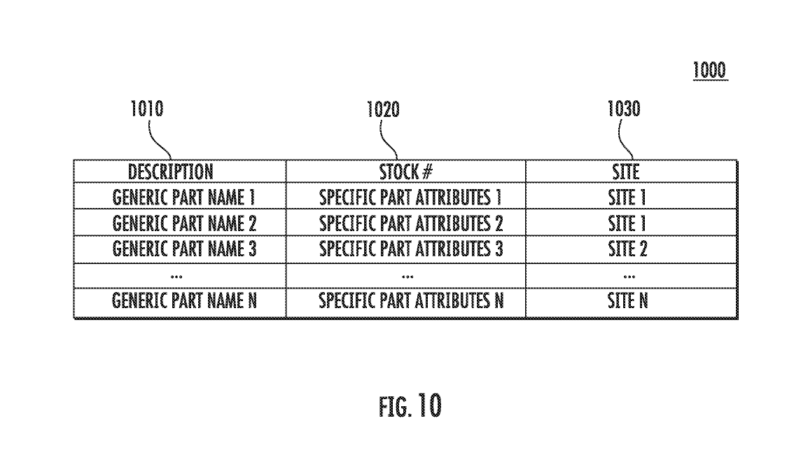

With the identification of parts based on the VIN of the vehicle and the parts earmarked for delivery, and all other parts from the vehicle, system 100 provides an opportunity to print tags for each of the respective parts in the respective categories of destination. Those earmarked parts may have tags printed and associated part by part to aid in the respective part reaching the proper destination. An illustration of such a screen 1000 for the printing of tags is shown in FIG. 10. As illustrated in screen 1000, a description of the part may be included within a description column 1010, stock number for a part included in the stock number column 1020 and the site location of the part included in the site column 1030. This may be itemized for each part included in a given row.

FIG. 11 illustrates a depiction 1100 of the print screens for printing tags within the present invention. A printer may be located with system 100 at a printer location 1110. Such a printer may print 1120 a tag associated with a part in the system that is arriving to or headed to the location 1110. The tag print 1130 may be adhered or co-located with the recovered part 1140. Using the printed tag 1130 the recovered part may be tracked and located within system 100.

The location of the parts may be identified within the present system as these parts make their way to the appropriate destination and once at their destination. FIG. 12 illustrates an illustration 1200 of location information with system 100. For example, bins may be identified for the placement of parts destined for selected resellers, for example. Other locations may be delineated for parts in the inventory process. Individual parts may be tags for warehousing, for example. As may be seen in illustration 1200 a part description may be included in a first column 1210. Other columns of information include status column 1215, age column 1220, price column 1225, type column 1230, location column 1235, user column 1240, date column 1245, condition column 1250, tag column 1255, stock number column 1260, site column 1265, resolution column 1270, comments column 1275, invoice number column 1280, restocked column 1285, dismantled date column 1290, and dismantler 1295, for example. Specific part attribute may also be included for each of the generic parts included within the illustration.

The methods provided can be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be maskworks that are then used in a semiconductor manufacturing process to manufacture a processor which implements features of the disclosure.

The methods or flow charts provided herein can be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method for identifying parts on a vehicle and maintaining the parts within a system, said method comprising:
submitting a vehicle identification number (VIN) to determine demand for one or a series of parts associated with the vehicle identified by the VIN;
generating a product delivery record (PDR) for at least one of the one or series of parts associated with the vehicle identified by the VIN;
entering the PDR of the at least one of the one or series of parts associated with the vehicle identified by the VIN into a tracking system;
determining an ultimate destination for the vehicle identified by the VIN;
on a condition that the vehicle is destined to be dismantled, creating at least one dismantle report associated with either the vehicle identified by the VIN or the at least one the one or series of parts associated with the vehicle identified by the VIN;
printing tags associated with the parts being dismantled from the vehicle, the tags providing at least one of routing or destination information for a part identified using the VIN of the vehicle; and
locating the parts based on the tag based on the routing or destination information.

2. The method of claim 1 wherein the submitting of the VIN occurs via a user input on a device.

3. The method of claim 1 wherein the VIN enables a determination of detailed attributes of the one or series of parts associated with the vehicle.

4. The method of claim 3 wherein the detailed attributes include trim level.

5. The method of claim 3 wherein the detailed attributes include interior color.

6. The method of claim 3, wherein the detailed attributes include interior package of the vehicle.

7. The method of claim 3 wherein the detailed attributes include exterior package of the vehicle.

8. The method of claim 1 wherein determining the destination of the vehicle includes determining the destination for the one or series of parts.

9. The method of claim 8 wherein the destination of one of the one or series of parts is different from a second of the one or series of parts.

10. The method of claim 1 further comprising tracking the one or series of parts associated with the vehicle.

11. A system for identifying parts on a vehicle and maintaining the parts within the system, said system comprising:
a user interface configured to receive an input vehicle identification number (VIN);
a processor operatively connected to the user interface, the processor configured to:
interact with a database to determine demand for one or a series of parts associated with the vehicle identified by the VIN;
generate a product delivery record (PDR) for at least one of the one or series of parts associated with the vehicle identified by the VIN; and
determine an ultimate destination for the vehicle identified by the VIN;
the user interface receiving the PDR of the at least one of the one or series of parts associated with the vehicle identified by the VIN into a tracking system;
on a condition that the vehicle is destined to be dismantled, the processor creating at least one dismantle report associated with either the vehicle identified by the VIN or the at least one the one or series of parts associated with the vehicle identified by the VIN; and
a printer receiving information from the processor and printing tags associated with the parts being dismantled from the vehicle, the tags providing at least one of routing or destination information for a part identified using the VIN of the vehicle to locate the parts based on the tag based on the routing or destination information.

12. The system of claim 11 wherein the VIN enables the processor to determine detailed attributes of the one or series of parts associated with the vehicle.

13. The system of claim 12 wherein the detailed attributes include trim level.

14. The system of claim 12 wherein the detailed attributes include interior color.

15. The system of claim 12, wherein the detailed attributes include interior package of the vehicle.

16. The system of claim 12 wherein the detailed attributes include exterior package of the vehicle.

17. The system of claim 11 wherein determining the destination of the vehicle includes determining the destination for the one or series of parts.

18. The system of claim 17 wherein the destination of one of the one or series of parts is different from a second of the one or series of parts.

19. The system of claim 11 further comprising tracking the one or series of parts associated with the vehicle.

20. A non-transitory computer readable storage media having computer-executable instructions, when executed by a processor, performing a method for identifying parts on a vehicle and maintaining the parts within a system, the instructions comprising:
submitting a vehicle identification number (VIN) to determine demand for one or a series of parts associated with the vehicle identified by the VIN;
generating a product delivery record (PDR) for at least one of the one or series of parts associated with the vehicle identified by the VIN;
entering the PDR of the at least one of the one or series of parts associated with the vehicle identified by the VIN into a tracking system;
determining an ultimate destination for the vehicle identified by the VIN;
on a condition that the vehicle is destined to be dismantled, creating at least one dismantle report associated with either the vehicle identified by the VIN or the at least one the one or series of parts associated with the vehicle identified by the VIN;
printing tags associated with the parts being dismantled from the vehicle, the tags providing at least one of routing or destination information for a part identified using the VIN of the vehicle; and
locating the parts based on the tag based on the routing or destination information.
